(19) United States
(12) Patent Application Publication
(10) Pub. No.: US 2025/0370778 A1
(43) Pub. Date: Dec. 4, 2025

(54) USING MULTIMODAL USER INPUT TO UPDATE A DIGITAL QUEUE DATA STRUCTURE

(71) Applicants: AMERICAN EXPRESS TRAVEL RELATED SERVICES COMPANY, INC., New York, NY (US); AMERICAN EXPRESS AUSTRALIA LIMITED, Sydney (AU); AMERICAN EXPRESS SERVICES EUROPE LIMITED, London (GB); AMERICAN EXPRESS INTERNATIONAL, INC. (AUSTRALIA), Sydney (AU)

(72) Inventors: Hunter KUBRYK, San Francisco, CA (US); Adrianus Johannes VAN DER MEER, Brighton (GB); Lekan IKOTUN, New York, NY (US); Shridevi BAICHWAL, Bella Vista (AU); Charles CANTRELL, San Mateo, CA (US); Eni FEZOLLARI, New York (NY); Cheng WENG, Sydney (AU); Rebecca Anne WIENKE, Los Angeles, CA (US); Angus WONG, New York, NY (US); Heather ZULIUM, Berkeley, CA (US); Hy NGUYEN, Berkeley, CA (US); Jonathan BRODHEIM, San Francisco, CA (US)

(21) Appl. No.: 19/305,608

(22) Filed: Aug. 20, 2025

Related U.S. Application Data
(63) Continuation-in-part of application No. 18/674,371, filed on May 24, 2024.

(51) Int. Cl. G06F 9/451; G06F 3/0482; G06F 3/0484; G06V 30/413

(52) U.S. Cl. CPC G06F 9/451; G06F 3/0482; G06F 3/0484; G06V 30/413

(57) ABSTRACT

When a queue time satisfies a queuing threshold for a facility (e.g., a lounge, a venue, merchant location, any defined area, etc.), a notification of the queue time may be sent to a user device. A user interface of the user device may be used to provide credential information, and based on the credential information, display an indication of a digital instrument. A selection of the digital instrument and/or additional multimodal user inputs may cause the user device to display a requirement for accessing the facility. Based on a confirmation of the requirement for accessing the facility and an indication that the queue time is less than the queuing threshold, the user device may display image data (e.g., a barcode, a matrix barcode, a quick response (QR) code, Radio Frequency Identification (RFID) tag, a marker, etc.) encoded with an access identifier that enables access to the facility.

### CROSS-REFERENCE TO RELATED APPLICATION

This application is a Continuation-In-Part of U.S. patent application Ser. No. 18/674,371, filed on May 24, 2024, which is incorporated by reference herein in its entirety.

### BRIEF SUMMARY

In a digital queuing system (e.g., a physical queuing system, an electronic queue, a wait and/or service line, etc.), when a queue time satisfies a queuing threshold for a facility (e.g., a lounge, a venue, merchant location, any defined area, etc.), a notification of the queue time may be sent to a user device. The improvement relates to the coordination of functionality between a digital queuing system and a digital instrument system, two systems that typically do not communicate with each other. A user interface of the user device may be used to provide credential information (e.g., a user/user device identifier, a password, a biometric, etc.). Based on the credential information, the user interface may display an indication of a digital instrument (e.g., a digital wallet account, a virtual card, a payment card, etc.). According to some aspects of this disclosure, the credential information may be associated with multiple digital instruments that are displayed by the user interface. A selection of a digital instrument may cause the user device to display a requirement for accessing the facility. According to some aspects of this disclosure, requirements for accessing the facility may change and/or be different based on which digital instrument is selected. Based on a confirmation of the requirement for accessing the facility and an indication that the queue time is less than the queuing threshold, the user device may display image data (e.g., a barcode, a matrix barcode, a quick response (QR) code, Radio Frequency Identification (RFID) tag, a marker, etc.) encoded with an access identifier that enables access to the facility.

A multimodal user input from a user device may be used to update a digital queue data structure. The improvement relates to consolidating and streamlining communications between disparate digital queue data structures existing within a digital queue system. Each digital queue data structure may correspond to a facility in a particular geographic location. However, contemporary digital queue data structures are generally not interconnected and require a series of complex, third-party helper protocols to communicate and transmit updates from one data structure to another. Even so, disparate data structures may include different definitions and have varying mechanisms for receiving and transmitting data. The aspects leverage a single graphical user interface to consolidate data structure organization processes. Moreover, the aspects do so through multiple user inputs modalities. Based on received digital instrument information, the user device may display a number of input options to for updating a digital queue data structure. The user device may transmit user input corresponding to a selected eligibility option (e.g., a QR code scan or an image upload from device memory). The system translates the multimodal user input into a readable data object for updating and organizing a multitude of digital queue data structures. For example, the system may extrapolate a predefined trigger event associated with the multimodal user input and perform an eligibility determination based on the extrapolation. The system may then update the digital queue data structure to include user information received from a user device. Accordingly, the system may update a first graphical user interface of a first user device and a second graphical user interface of a second user device based on the updated digital queue data structure.

### BRIEF DESCRIPTION OF THE DRAWINGS

The accompanying drawings are incorporated herein and form a part of the specification.

FIG. 1A shows a block diagram of a system for location queuing using digital instruments, according to some aspects of this disclosure.

FIG. 1B shows a block diagram of a system for updating a digital queue data structure, according to some aspects.

FIGS. 2A-2D show an example user interface for location queuing using digital instruments, according to some aspects of this disclosure.

FIG. 3 shows a flowchart of an example method for location queuing using digital instruments, according to some aspects of this disclosure.

FIGS. 4A-4F show example interfaces for updating a digital queue data structure using a multimodal user input, according to some aspects of this disclosure.

FIG. 5 shows an example interface indicating that the digital queue data structure has not been updated based on the multimodal user input, according to some aspects of this disclosure.

FIG. 6 shows an example interface indicating that the digital queue data structure has been updated based on the multimodal user input, according to some aspects of this disclosure.

FIG. 7 shows an example interface of an administrator device receiving the updated digital queue data structure, according to some aspects of this disclosure.

FIG. 8 shows a flowchart of an example method for using a multimodal user input interface to update a digital queue data structure, according to some aspects of this disclosure.

FIG. 9 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof, for location queuing using digital instruments and updating a digital queue data structure using a multimodal user input. Current queuing systems struggle with efficient queue management, such as management of occupancy in public and private spaces, particularly in environments where safety and user experience are paramount, because these systems typically rely exclusively on manual interaction. For example, a user may have to present his name or identification to a customer service agent managing the queue. The customer service agent may then enter the user's information into the queuing system. Manual action within current queuing systems can lead to excessive wait times and/or long queues for users and/or user devices to access facilities (e.g., a lounge, a venue, merchant location, etc.), utilize services, and/or the like as populations increase and demand to access facilities, utilize services, and/or the like increase accordingly. The problem with current queuing systems and their failure to communicate with other digital system, which leads to excessive wait times and long queues, presents a significant technical challenge and detracts from user satisfaction. With regard to facility access, such delays are primarily caused by traditional access and/or entry procedures that rely on manual check-ins, physical verification of eligibility through paperwork or digital devices, and a lack of real-time data processing capabilities. For example, conventional methods of managing entry to a facility such as an airport lounge and/or the like are inefficient, time-consuming, and often unable to cope with high volumes of uses and/or user devices, especially during peak travel times and other high volume periods. Furthermore, the physical space designated for queues (e.g., wait lines, etc.) often becomes overcrowded, leading to discomfort and a stressful environment.

Conventional queue management and occupancy systems often fail to provide real-time capacity and occupancy data, lack digital interaction capabilities, and are not scalable to different environments or user volumes. With conventional queue management and occupancy systems, users/user devices are unable to enter a queue and/or join a waitlist for access to a facility since the users/user devices are routinely unaware that the waitlist is active without physically visiting the facility. When physically visiting a facility, users/user devices are routinely required to wait in a physical line and/or manually engage support personnel. Conventional queue management and occupancy systems struggle to efficiently manage varying flow rates of user and user devices, which can fluctuate dramatically. Inefficiencies in queue management and facility entry processes can also pose security risks, as hurried user and user device evaluations may lead to oversight and reduced effectiveness of security protocols.

Moreover, many convention queue management systems struggle to facilitate communications among multiple digital queue data structures operating across a large scale wide area network. Such systems inadequately consolidate changes from one digital queue data structure to another. For example, contemporary digital queue data structures are not interconnected and require a series of complex, third-party helper protocols to communicate and transmit updates from one data structure to another. Even so, disparate data structure components may be defined differently and have varying mechanisms for receiving and transmitting data. One instance of this stems from how a digital queue data structure receives user input. Many digital queue systems fail to reconcile multiple forms of user input. In other words, one particular data structure component may only operate on one type of user input while another data structure may only operate on a different type of user input.

According to some aspects of this disclosure, a system, apparatus, device, method and/or computer program product aspects, and/or combinations and sub-combinations thereof, for location queuing using digital instruments may leverage location observation data, sensor data, digital instrument data, and/or the like for real-time monitoring of capacity and occupancy levels in a facility (e.g., a lounge, a venue, merchant location, any defined area, etc.) and managing queuing between users within the digital queuing system. In a crowded area including, but not limited to, an airport lounge and/or the like, location queuing using digital instruments, as described herein, facilitates optimal occupancy at least in part via automated notifications and a digital/virtual waitlist management for potential entrants in proximity to the area. The improvements of the queuing system in coordination with digital instrument systems facilitate user interfaces for viewing the current occupancy status of a facility, joining a digital/virtual waitlist, and transmitting and receiving notifications as space becomes available, thus optimizing user flow and space utilization.

According to some aspects of this disclosure, a system, apparatus, device, method, and/or computer program product aspects, and/or combinations and sub-combinations thereof, for using multimodal user input from a user device to update a single or multiple digital queue data structure may leverage a single graphical user interface to consolidate data structure organization processes. Particular physical environments that are linked to digital queue data structures (e.g., a lounge, a venue, merchant location, any defined restricted area, etc.) may require a streamlined and consolidated user input mechanism(s) to organize the data structure in a computationally efficient and accurate manner. Therefore, the improvements of the digital queue management system facilitates a more efficient and precise computational coordination among the disparate digital queue data structures existing within a digital queue system.

As described herein, at least the technical fields of data structure optimization, distributed data management, capacity management, logistic management and/or the like are improved by the system, apparatus, device, method and/or computer program product aspects, and/or combinations and sub-combinations thereof, for location queuing using digital instruments which streamline the entry process into facilities, enhance the user experience by significantly reducing wait times for certain users, and improve the overall efficiency and security of facility entry operations. As further described herein, features relate to an improvement in the functioning of digital queuing systems by combining the use of location queuing using digital instruments with digital instrument systems to manage digital queuing and management of the digital queue. Moreover, the data structure optimization techniques described herein enable more efficient communications over a network for the management of multiple location queues across different physical locations and synchronization with user devices, location queuing systems, and digital instrument systems.

According to some aspects of this disclosure, location queuing using digital instruments and updating a digital queue data structure through multimodal user input may be implemented via a digital queuing application configured with a user device and/or the like. The digital waitlist application enhances the functioning of a computer, particularly in environments including, but not limited to, airports, service centers, healthcare facilities, restaurants, and/or any queue-based setting, by organizing and managing the demand for computational resources or services efficiently. By managing the use of CPU, memory, and storage utilities invoked to facilitate access to a location, computational resources are allocated effectively based on priority and necessity. For example, computational resources used to identify a queue/wait time for a user device to access a facility may be reduced by identifying a digital instrument associated with the user device that enables expedited access to the facility. The digital queuing application ensures that computing systems managing access to locations/facilities do not become overloaded and reduces the risk of system freezing, crashing, and/or the like-thereby improving reliability. The digital queuing application may provide valuable data on facility usage patterns, peak operating times, typical queue/wait times, preferred user input modalities, and facility access eligibility. This data can be used to further refine resource allocation strategies and system configurations for continuous improvements in system performance. These and other technological advantages are described herein.

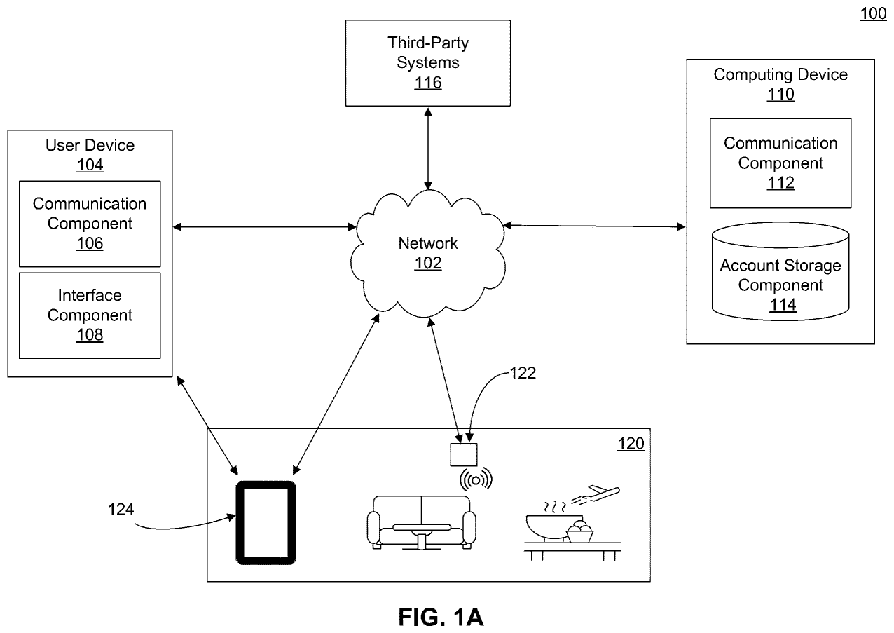

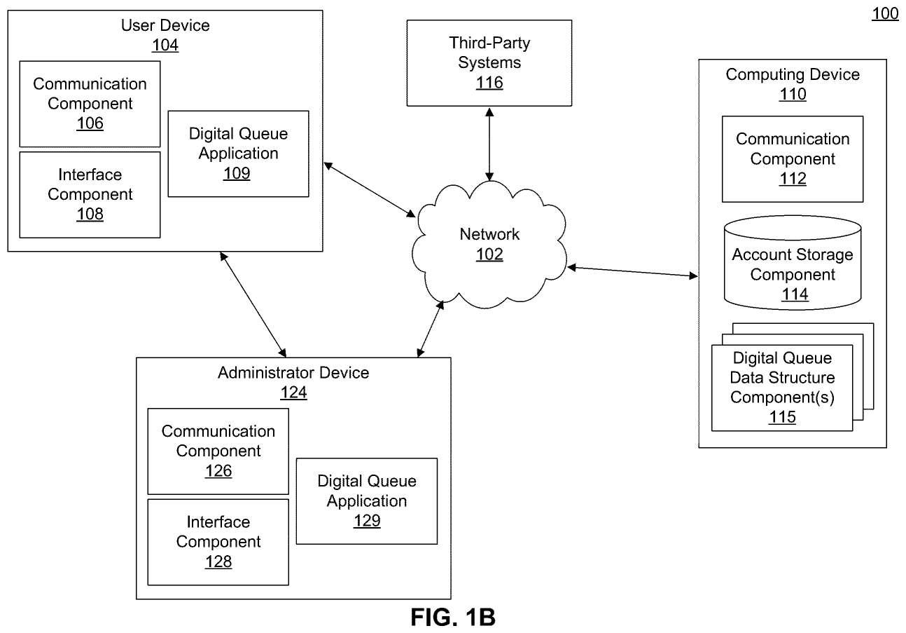

FIG. 1A shows an example system 100 for location queuing using digital instruments. System 100 is merely an example of one suitable environment and is not intended to suggest any limitation as to the scope of use or functionality of aspects described herein. System 100 should not be interpreted as having any dependency or requirement related to any single device/component or combination of devices/components described therein.

System 100 may include a network 102. According to some aspects of this disclosure, system 100 may include a network 102. Network 102 may include a packet-switched network (e.g., internet protocol-based network), a non-packet-switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may include a payment network and/or may support/facilitate financial transactions. Network 102 may provide and/or support communication from a telephone, cellular phone, modem, and/or other electronic devices to and throughout the system 100. For example, system 100 may include and support communications between a user device 104, a computing device 110, and a third-party system 116 via network 102.

User device 104 may include a smart device, a mobile device, a computing device, and/or any other device capable of communicating with network 102 and/or device/components in communication with network 102. Although only a single user device 104 is shown, according to some aspects of this disclosure, system 100 may include any number of user devices 104.

User device 104 may include a communication component 106 that facilitates and/or enables communication with network 102 (e.g., devices, components, and/or systems of network 102, etc.), computing device 110, third-party system 116, and/or any other device/component of the system 100. For example, communication component 106 may include hardware and/or software to facilitate communication. Communication component 106 may comprise one or more of a modem, transceiver (e.g., wireless transceiver, etc.), digital-to-analog converter, analog-to-digital converter, encoder, decoder, modulator, demodulator, tuner (e.g., Quadrature Amplitude Modulation (QAM) tuner, Quadrature Phase Shift Keying (QPSK) tuner), and/or the like. Communication component 106 may include any hardware and/or software necessary to facilitate communication.

According to some aspects of this disclosure, user device 104 may include an interface component 108. Interface component 108 enables a user to interact with user device 104, network 102, computing device 110, third-party system 116, and/or any other device/component of system 100. Interface component 108 may include any interface for presenting and/or receiving information to/from a user. According to some aspects of this disclosure, interface component 108 may include a web browser, a mobile device application (e.g., a digital queuing/waitlist application, a payment application, etc.), and the like. Other software, hardware, and/or interfaces can be used to provide communication between user device 104, network 102, computing device 110, third-party system 116, and/or any other device/component of system 100. Interface component 108 may request/query and/or send/provide various files from a local source and/or a remote source, such as computing device 110, third-party system 116, and/or any other device/component of system 100.

According to some aspects of this disclosure, interface component 108 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, interaction with the input devices and/or components may enable a user to view, access, interact, request, and/or navigate a user interface generated, accessible, and/or displayed by interface component 108. According to some aspects of this disclosure, interaction with the input devices and/or components may enable a user to manipulate and/or interact with components of a user interface. For example, interaction with the input devices and/or components of interface component 108 enables a user to log in and/or navigate to a digital waitlist associated with a facility, such as facility 120.

User device 104 may include and/or be associated with a digital wallet. The digital wallet may include payment information and passwords associated with user device 104 (e.g., associated with a user of user device 104). For example, the digital wallet may include information related to a digital instrument such as a payment card and/or the like. A payment card may be associated with a primary account number (PAN). In some instances, the PAN may be tokenized for security. The PAN associated with user device 104 may be stored by a payment network (e.g., a payment network configured with, supported by, and/or enabled by network 102, etc.) in a database record linked to a payment account (and/or user profile) associated with a user (e.g., a user associated with and/or using user device 104, etc.). For example, a user device 104 (or user of user device 104) may be associated with a unique identifier that is linked to a digital wallet. The digital wallet may be linked and/or associated with different digital instruments, payment utilities, and/or methods, for example, a payment account.

A payment account represented by a digital instrument and linked to a digital wallet may be maintained/controlled by a third-party system 116. For example, third-party system 116 may include and/or be part of a device/network associated with a financial institution that issues the payment account. According to some aspects of this disclosure, although not shown, system 100 may include multiple third-party systems 116. According to some aspects of this disclosure, the digital wallet may be associated with multiple digital instruments that are each supported by one or more third-party systems 116. Each digital instrument may also be associated with different parameters that may be shared with a digital queuing application. The digital queuing application may then use the different parameters to condition access to a digital queue.

According to some aspects of this disclosure, a digital instrument, such as a payment card and/or the like, may be associated with various services, rewards, and/or programs supported by third-party systems and available to a user and/or user device 104. For example, a digital instrument may be associated with conditions, a service, reward, and/or program that permits or provides certain conditions for processing by the digital queuing application (e.g., for a user and/or user device 104 to access facility 120).

According to some aspects of this disclosure, facility 120 may include any location, area, building, room, and/or the like. For example, facility 120 may include an airport lounge and/or the like. Entry to facility 120 may be available to users and/or user devices associated with a digital instrument, such as a payment card and/or the like.

According to some aspect of this disclosure, facility 120 may include one or more sensors, such as sensor 122. Sensor 122 may include, but is not limited to an imaging device, a motion detection device, an infrared sensing device, a light detection and ranging (LiDAR) device, and/or the like. Sensor 122 may be positioned within facility 120 to monitor the amount of user/users devices within facility 120. Information from sensor 122 may be sent to computing device 110.

Computing device 110 may manage access to facility 120. According to some aspects of this disclosure, computing device 110 may include an entity-controlled device, a server, a cloud-based compute resource, or any other device capable of communicating with user device 104, third-party systems 116, facility 120 (e.g. sensor 122, etc.) and/or any other device/component of system 100, either described or (un) shown. Although shown as a single device, according to some aspects of this disclosure, computing device 110 may be part of a computing system and/or infrastructure, and/or may represent a plurality of computing devices. For example, computing device 110 may represent a plurality of computing devices in communication with user device 104, third-party systems 116, and/or any other device/component of system 100.

According to some aspects of this disclosure, computing device 110 may include communication component 112 that facilitates and/or enables communication with network 102 (e.g., devices, components, and/or systems of network 102, etc.), user device 104, third-party systems 116, and/or any other device/component of system 100. For example, communication component 112 may include hardware and/or software to facilitate communication. According to some aspects of this disclosure, communication component 112 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication component 112 may include any hardware and/or software necessary to facilitate communication.

According to some aspects of this disclosure, to manage access to facility 120, computing device 110 may include an account storage component 114. Account storage component 114 may include any physical, virtual, cloud-based, and/or network-based storage medium. Account storage component 114 may store account information for user device 104 that indicates digital instruments associated with user device 104. For example, user device 104 (e.g., users of user device 104, etc.) may have digital instruments provided by and/or registered with third-party system 116 that, based on their type, offer and/or support various rewards, value-add options, and/or user experience options. An example reward, value-add option, and/or user experience option may be an option to access facility 120.

According to some aspects of this disclosure, to access facility 120, user device 104 may provide one or more access requirements associated with a user account. Access requirements for facility 120 may be dynamic. For example, access requirements may change and/or be different for users/user devices 104 based on a type of digital instrument associated with the users/user devices 104. Facility 120 communicate with third party systems 116 and/or communication device 110 to identify the account associated with the digital instrument. In a situation where facility 120 is an airport lounge, access requirements for facility 120 may include, but are not limited to, a boarding pass, an identification element (e.g., a government issued ID, a digital identifier, a biometric, etc.), group/program membership, a qualifying airline ticket, a temporal requirement (e.g., accessing the facility within a certain timeframe, etc.), a location requirement (e.g., a lounge is at a specific departing or connecting airport, etc.), user requirements (e.g., amount of guests permitted, guest restrictions, and/or the like. This information may be shared by one or more of user device 104, third party systems 116, and/or communication device 110. For example, the information may be identified based on the digital wallet associated with user device 104, the one or more digital instruments associated with the digital wallet provided by third party system 116, and/or user information from computing device 110.

According to some aspects of this disclosure, to manage access to facility 120, computing device 110 may include a kiosk and/or terminal positioned in proximity to facility 120. According to some aspects of this disclosure, a user of computing device 110 may monitor users/user devices entering and exiting facility 120 to determine a capacity for facility 120. When a capacity level and/or queue threshold for facility 120 is reached, computing device 110 may send a notification to users/user devices within proximity to facility 120. The notification may (or may not) inform users/user devices (e.g., user device 104, etc.) that the queue threshold for facility 120 is satisfied and may indicate an option to join a waitlist.

According to some aspects, to manage access to facility 120, administrator device 124 may receive digital queue information from computing device 110. Administrator device 124 may be, but is not limited to, a desktop computer, laptop, tablet, smartphone, kiosk, or a scanning device. Administrator device 124 may receive information from computing device 110, such as account storage information from account storage component 114. Administrator device 124 may also communicate directly with user device 104. For example, administrator device 124 may scan a QR code displayed on user device 104.

According to some aspects of this disclosure, to manage access to facility 120, as previously described, information from sensor 122 may be sent to computing device 110. For example, sensor 122 may send computing device information indicating users/user devices within facility 120. If a threshold amount of users/user devices are detected within facility 120 (e.g. a capacity is detected, a queue threshold is reached, etc.), computing device 110 may send notification to users/user devices within proximity to facility 120. The notification may (or may not) inform users/user devices (e.g., user device 104, etc.) that a queue threshold for facility 120 is satisfied and may indicate an option to join a waitlist.

According to some aspects of this disclosure, computing device 110 may include software and/or hardware that uses communication protocols including, but not limited to HTTP (Hypertext Transfer Protocol) and/or the like to communicate information with user device 104. Computing device 110 may communicate information to user device 104 that is used to generate, render, and/or cause to display a user interface, for example, a user interface for managing access to facility 120. For example, the user interface may display information, such as a notification that a queue threshold for facility 120 is satisfied, and indicate an option to join a waitlist. Moreover, the user interface may display information relating to whether the user is authorized to enter a facility 120.

According to some aspects of this disclosure, to cause user device 104 to display a user interface for managing access to facility 120 and/or join a waitlist for access to facility 120, computing device 110 may include and/or be configured with a representational state transfer (REST) API that facilitates interactions with RESTful services, such as interactive elements (e.g., waitlist/queue indicators, selectable items, informational items, etc.) and/or the like. According to some aspects of this disclosure, displaying, rendering, and/or presenting interactive elements may be facilitated via a just-in-time compiled programming language such as JavaScript, Typescript, Dart, ClojureScript, Ruby, Python, and/or the like. Additionally, technology including JavaScript with dynamic generation of a Document Object Model (DOM), Cascading Style Sheets (CSS), jQuery, Asynchronous JavaScript and XML (AJAX), and code libraries may be used to generate, render, and/or cause the display of one or more interactive elements within a user interface.

According to some aspects of this disclosure, computing device 110 (and user device 104) may use any user interface interaction method to cause a user interface to display a user interface for managing access to facility 120. The user interface may not only manage the flow of users/user device 104 accessing facility 120 based on capacity but may also prioritizes access based on digital instrument types which may be associated with various membership tiers.

FIG. 1B shows example system 100 used for using a multimodal user input to update a digital queue data structure component(s). FIG. 1B shall be explained with reference to the elements of FIG. 1A. Specifically, system 100 of FIG. 1B includes elements that are emphasized in greater detail as well as additional elements. However, FIG. 1B is not limited to this example aspect.

In some aspects, user device 104 may include a digital queue application 109. Digital queue application 109 may reflect programmable instructions executable by user device 104. Digital queue application 109 may be implemented locally as a standalone device application and/or as a web application. User device 104 may be configured to enable digital wallet information to be integrated within the digital queue application 109. For example, digital queue application 109 may be configured to store and display a list of digital instruments associated with a digital wallet (e.g., a credit card account). The digital instruments utilized by digital queueing application 109 may also be tokenized for additional transactional security. If user device 104 receives a selection of a digital instrument through digital queue application 109, user device 104 may transmit a PAN, a tokenized PAN, and/or other account identifiers associated with the digital instrument to other entities within system 100 (e.g., third-party systems 116, computing device 110, and/or administrator device 124).

According to some aspects, digital queue application 109 may be communicatively coupled to interface 108 to display information via a graphical user interface. Additionally, digital queue application 109 may be communicatively coupled to communication component 106 to transmit information from user device 104 to computing device 110, third-party systems 116, administrator device 124, or a combination thereof.

According to some aspects of this disclosure, computing device 110 may include a digital queue data structure component 115. Digital queue data structure component 115 may include a number of stored data structures. A stored data structure may resemble, but is not limited to, a queue, a stack, a linked list, or an array. The stored data structure may also specify a list of users, devices, or a combination thereof. The list may specify whether the respective user, device, or combination thereof is eligible to enter a particular facility 120.

According to some aspects of this disclosure, digital queue data structure component 115 may additionally include a set of programmable instructions (also referred to as eligibility criteria) configured to perform operations relating to whether an entry (e.g., a user and/or device) may be added to a stored data structure (i.e., an eligibility determination). The eligibility criteria may perform eligibility determinations based on information entered into digital queue application 109 as well as other information transmitted from user device 104 (e.g., an IP address, MAC address, geolocation data, etc.).

According to some aspects of this disclosure, administrator device 124 may receive information corresponding to a stored data structure in digital queue data structure component 115. User device 104 may transmit information to computing device 110 that is evaluated by digital queue data structure component 115. Based on the result of the operations performed by digital queue data structure component 115, computing device 110 may transmit an update data structure(s) from component 115 to administrator device 124.

According to some aspects of this disclosure, administrator device 124 may communicate directly with user device 104. For example, administrator device 124 may scan or read information on user device 104 through digital queue application 109. Digital queue application 109 may include an interface configured to display a bar code, QR code, or other mechanisms readable by administrator device 104.

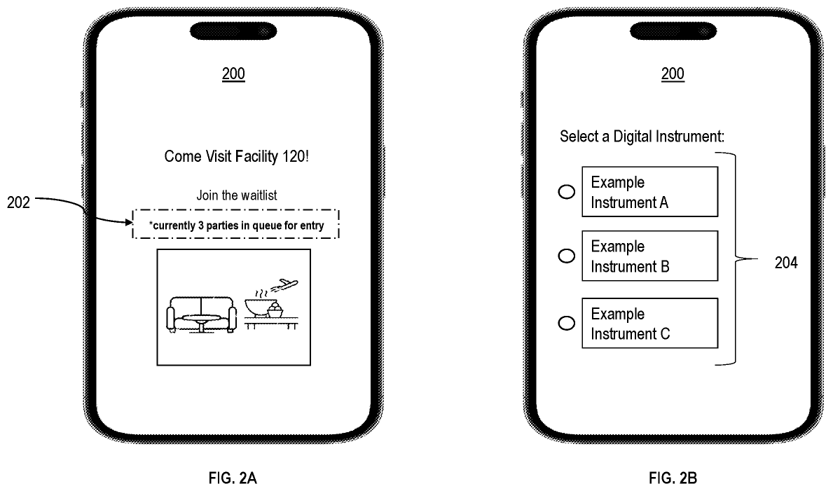

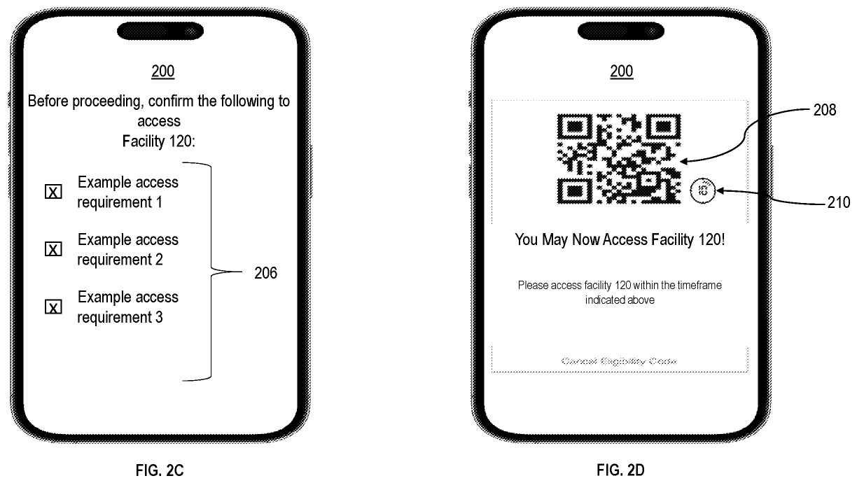

FIG. 2A shows an example user interface 200 for location queuing using digital instruments. In an example scenario, a user of user device 104 may scan a QR code and/or the like located at an entrance to facility 120. A scan of the QR code may cause user interface 200 to display indicator 202. Indicator 202 may indicate current queue information for facility 120. For example, as shown indicator 202 may indicate the amount of users waiting in queue to enter facility 120. In another example scenario, a user of user device 104 may receive a notification or instruction from computing device 110 that causes user device 104 to display user interface 200. For example, computing device 110 may send a notification or instruction to user device 104 that causes user device 104 to display user interface 200 based on user device 104 being in proximity to facility 120.

To access facility 120 according to the current queue information, user interface 200 may be used to provide credentials for user device 104 and or a user of user device 104. Submission of valid credentials may cause user device 104 to display user interface 200 as shown in FIG. 2B. As shown in FIG. 2B, user interface 200 may display an indication of a digital instrument (e.g., example instrument A, etc.). According to some aspects of this disclosure, when a user/user device 104 is associated with multiple digital instruments, user interface 200 may display a list 204 of digital instruments (e.g., example instrument A, example instrument A, example instrument B, example instrument C, etc.).

According to some aspects of this disclosure, information on list 204 may be displayed in any order. According to some aspects of this disclosure, list 204 may be ordered according to the frequency of use of the digital instruments. According to some aspects of this disclosure, list 204 may be ordered according to membership and/or group types associated with the digital instruments. According to some aspects of this disclosure, list 204 may be may be a ranked list of digital instruments. A rank for a digital instrument may be based on a digital instrument type, a membership/group/tiered program (e.g., prioritized status, platinum/gold status, basic/general status, etc.) associated with a digital instrument, a frequency of use, user preferences, and/or the like.

According to some aspects of this disclosure, computing device 110 may include one or more predictive models specifically trained to rank digital instruments based on various factors including, but not limited to, digital instrument type, companion/guess access availability, user preferences, reward/benefit program membership, time-of-day, historical facility access data, and/or the like. A predictive model may be specifically trained to rank digital instruments according to any factors. In other aspects, a predictive model may be implemented at user device 104 or in a device implemented at facility 120.

According to some aspects of this disclosure, predictive models associated with computing device 110 may be trained based on labeled datasets (generated from feature engineering, etc.) relating to, but not limited to, ranking parameters, historical data describing digital instrument ranking, digital instrument usage patterns, reward/value program information, and/or the like. Predictive models associated with computing device 110 may include, but are not limited to, regression models, classification models, and/or the like. According to some aspects of this disclosure, predictive models associated with computing device 110 may utilize linear regression, decision trees, random forests, gradient boosting machines, neural networks, and/or the like suitable for ranking digital instruments to facilitate location queuing using digital instruments and/or the like.

When training predictive models associated with computing device 110, data used in developing datasets may be split into a training set and a validation set, where the training set is used to train the predictive model(s), and the validation set is used to tune the predictive model(s) parameters and avoid overfitting. The performance of predictive models associated with computing device 110 may be evaluated according to relevant metrics. For example, for regression tasks, a relevant metric may be mean absolute error (MAE) or root mean square error (RMSE). For classification tasks, a relevant metric may include, but is not limited to, accuracy, precision, recall, and/or the like. Once a predictive model associated with computing device 110 is trained and evaluated, it can be used to make predictions on new data. The predictive model may be periodically retrained on new data, to ensure the predictive model remains accurate as conditions change.

A digital instrument listed in list 204 may be selected via an interaction with user interface 200. According to some aspects of this disclosure, a selection of a digital instrument may cause user device 104 to display additional screens or options of user interface 200. For example, a selection of a digital instrument may cause user device 104 to display an interactive element for confirming and/or providing contact information (e.g., a phone number, texting information, email, etc.) associated with a user/user device 104 that may be used to receive notifications associated with facility 120. Notifications associated with facility 120 may include, but are not limited to, notifications that indicate a waitlist status for facility 120, notifications detailing when access to facility 120 is available, and/or the like. According to some aspects of this disclosure, a selection of a digital instrument may cause user device 104 to display an additional screen or option of user interface 200 such as a screen or option to add guests of user/user device 104 as intended visitors to facility 120.

As previously described, each digital instrument may be associated with one or more requirements for access facility 120. A selection of a digital instrument displayed by user interface 200 causes user interface 200 to display one or more access requirements associated with the digital instrument and/or the type of digital instrument. FIG. 2C shows an example of user interface 200 depicting a list 206 of access requirements for accessing facility 120 that are associated with a digital instrument selected in FIG. 2B.

Based on the confirmation of the access requirements for accessing facility 120 indicated by list 206, computing device may place user device 104 into a queue (on a waitlist) for accessing facility 120. According to some aspects of this disclosure, a queuing threshold and/or queue time for user device 104 to access facility 120 may be based on a type of digital instrument selected in FIG. 2B. For example, based on a first type of digital instrument selected (e.g., example instrument A, etc.), computing device 110 may send a notification to user device 104 instructing user device immediate access (e.g., no queue time/threshold, no need to wait on a waitlist, etc.) is available to facility 120. Based on a second type of digital instrument selected (e.g., example instrument B, etc.), computing device 110 may send a notification to user device 104 informing user device 104 that access to facility 120 may be available within a predefined timeframe (e.g., a reduced queue time/threshold, a need to wait on a waitlist, etc.). Notifications regarding access to facility 120 may be sent to user device 104 via contact information (e.g., a phone number, texting information, email, etc.) associated with a user/user device 104.

To enable access to facility 120, computing device 110 may generate an access identifier. The access identifier may be sent to user device 104 to be presented at an entrance of facility 120 and facilitate access to facility 120. According to some aspects of this disclosure, an access identifier for facility 120 may be encoded into image data (e.g., a barcode, a matrix barcode, a quick response (QR) code, Radio Frequency Identification (RFID) tag, a marker, etc.). User device 104 may display the image data based on confirmation of the requirement for accessing the facility. For example, user device 104 may receive a notification that space is available within facility 120 and that user device 104 (a user of user device 104, etc.) may access facility 120.

FIG. 2D shows an example of user interface 200 depicting image data 208 (e.g., a barcode, a matrix barcode, a quick response (QR) code, Radio Frequency Identification (RFID) tag, a marker, etc.) that has been encoded with an access identifier that facilitates access to facility 120. According to some aspects of this disclosure, image data 208 may be displayed along with a time element 210. Time element 210 may indicate an amount of time during which the access identifier for accessing facility 120 is valid and/or may facilitate access to facility 120. The image data may be decoded by a user or entry device (e.g., computing device 110, etc.) associated with facility 120, and the access identifier may be used to access the facility.

According to some aspects of this disclosure, user interface 200 may display a route (not shown) from a current location of user device 104 to facility 120. For example, a current location of user device 104 may be determined via the GPS functionality of communication component 106 and sent to computing device 110. Additionally and/or alternatively, Wi-Fi triangulation, Bluetooth beacons, and/or the like within an area surrounding facility 120 and user device 104 may be used to identify the location of user device 104.

Computing device 110 may receive an indication of the location of user device 104 and access a mapping system (e.g., an airport geographic information system (GIS)) to identify optimal routes within the area (e.g., an airport, etc.) surrounding facility 120 and user device 104. To identify optimal routes, a predictive model of computing device 110 may consider various factors such as distance, current crowd levels (e.g., based on information received from one or more sensors, imaging devices, etc.), and identify any obstructions (e.g. maintenance, detours, emergencies, etc.). The predictive model may use algorithms including, but not limited to, Dijkstra's, A* (A-star), and/or the like to identify the shortest path from the current location of user device 104 and facility 120.

Computing device 110 may send an indication of an identified optimal route to user device 104 to guide user device 104 toward facility 120. According to some aspects of this disclosure, a route may be displayed by user device 104 via an interactive map of user interface 200. The interactive map may include step-by-step directions, options to display an estimated time of arrival (ETA) at facility 120, notifications for any changes in the optimal route, and/or the like.

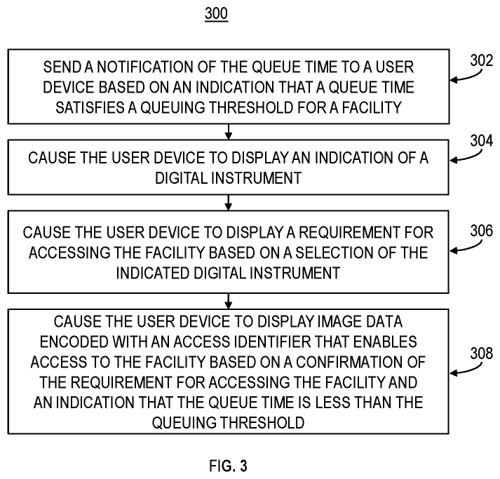

FIG. 3 shows a flowchart of an example method 300 for location queuing using digital instruments, according to some aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIGS. 1-2C. However, method 300 is not limited to the aspects of those figures.

In 302, computing device 110 sends a notification of the queue time to a user device, such as user device 104. Computing device 110 may send the notification of the queue time to the user device based on an indication that a queue time satisfies a queuing threshold for a facility (e.g., a lounge, a venue, merchant location, any defined area, etc.).

According to some aspects of this disclosure, computing device 110 may generate an indication that the queue time satisfies the queuing threshold for the facility based on sensor data from a sensing device associated with the facility that indicates a service capacity for the facility. For example, one or more sensors associated with the facility may collect data at defined intervals to track the presence and flow of user/user device within the facility. Sensors may include, but or not limited to, These may include infrared sensors for detecting body heat, motion detectors for detecting user/user device motion within the facility, imaging devices that use image recognition to identify user/user devices entering and exiting the facility, and/or the like. Computing device 110 may process data from sensors associated with the facility to assess real-time occupancy levels and identify when these levels reach a set maximum capacity (e.g., queuing threshold, etc.) for the facility.

According to some aspects of this disclosure, to receive the notification of the queue time, the user device may access a uniform resource locator (URL) and/or scan a quick response (QR) code associated with the facility. Accessing the URL and/or scanning the QR code may cause the user device to display the notification of the queue time. According to some aspects of this disclosure, computing device 110 may send the notification of the queue time to the user device based on an indication that the user device is within proximity to the facility. According to some aspects of this disclosure, to receive the notification of the queue time, the user device may be configured with an application that receives occupancy data for the facility and notifies the user device of the queue time.

In 304, computing device 110 causes the user device to display an indication of a digital instrument. Computing device 110 may cause the user device to display the indication of the digital instrument based on credential information (e.g., a user/user device identifier, a password, a biometric, etc.) received from the user device. According to some aspects of this disclosure, computing device 110 causing the user device to display the indication of the digital instrument may include computing device 110 causing the user device to display a ranked list of digital instruments. The selected digital instrument may be a highest-ranked digital instrument indicated by the ranked list of digital instruments. The selected digital instrument may be any ranked digital instrument indicated by the ranked list of digital instruments. A rank for a digital instrument may be based on a digital instrument type, a frequency of use, user preferences, and/or the like.

In 306, computing device 110 causes the user device to display a requirement for accessing the facility. Computing device 110 may cause the user device to display the requirement for accessing the facility based on a selection of the indicated digital instrument. For example, computing device 110 may support different types and/or classifications of digital instruments, and each digital instrument may be associated with one or more requirements for accessing the facility. For example, when the facility is an airport lounge, requirements for access to the facility may include, but are not limited to, a boarding pass, an identification element, a membership, a qualifying airline ticket, a temporal requirement (e.g., accessing the facility within a certain timeframe, etc.), a location requirement, and/or the like.

According to some aspects of this disclosure, computing device 110 adjusts the queuing threshold based on the type of the digital instrument. For example, a first type of digital instrument may enable a user/user device associated with the digital instrument to access the facility without traversing a queue or waiting on a waitlist for the facility. A second type of digital instrument may require a user/user device associated with the digital instrument to access the facility once the queue time for the facility and/or amount of user/user devices on a waitlist for the facility is less than a specific value.

In 308, computing device 110 causes the user device to display image data (e.g., a barcode, a matrix barcode, a quick response (QR) code, Radio Frequency Identification (RFID) tag, a marker, etc.) encoded with an access identifier that enables access to the facility. Computing device 110 may cause the user device to display the image data based on confirmation of the requirement for accessing the facility and an indication that the queue time is less than the queuing threshold. According to some aspects of this disclosure, the matric barcode may be displayed by a user interface of the user device and may include a timer in proximity to the image data that indicates the amount of time that the access identifier is valid for accessing the facility. The image data may be decoded by a user or entry device associated with the facility and the access identifier may be used to access the facility.

According to some aspects of this disclosure, method 300 may include computing device 110 causing the user device to display a route from a location where the user device is located to the facility and/or an estimated time of arrival for the user/user device to travel to the facility based on an indication of the location received from (or detected for) the user device.

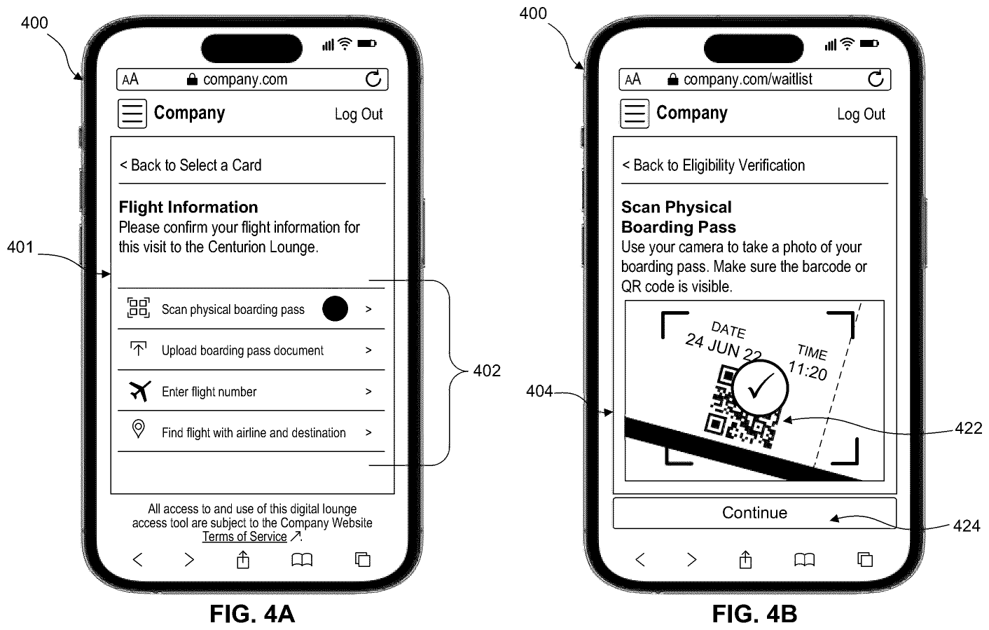

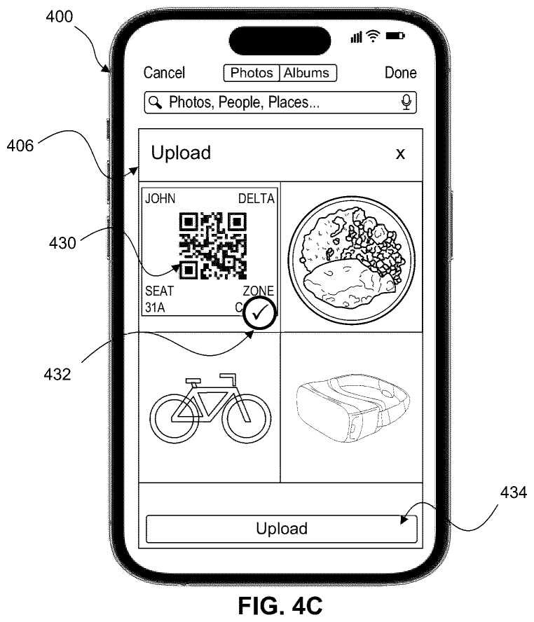

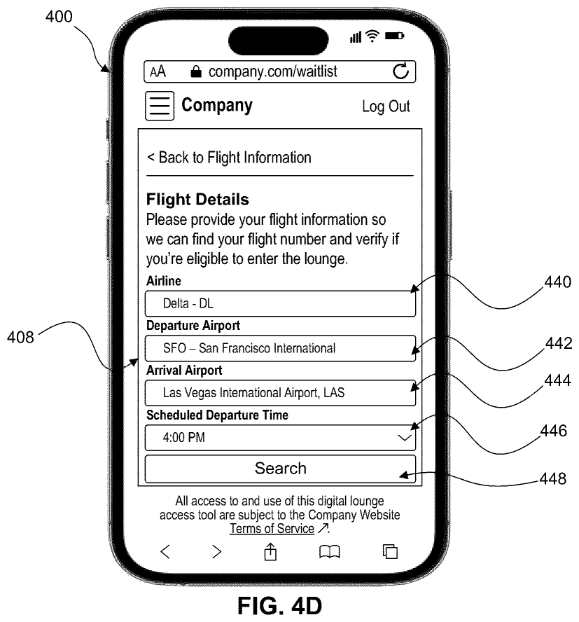

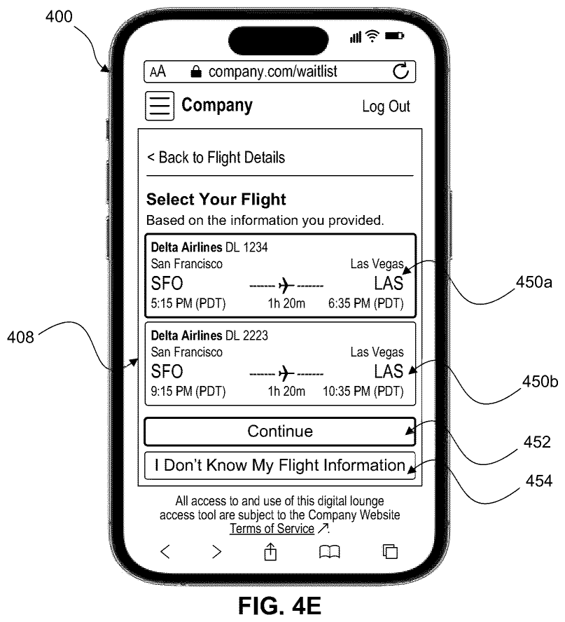

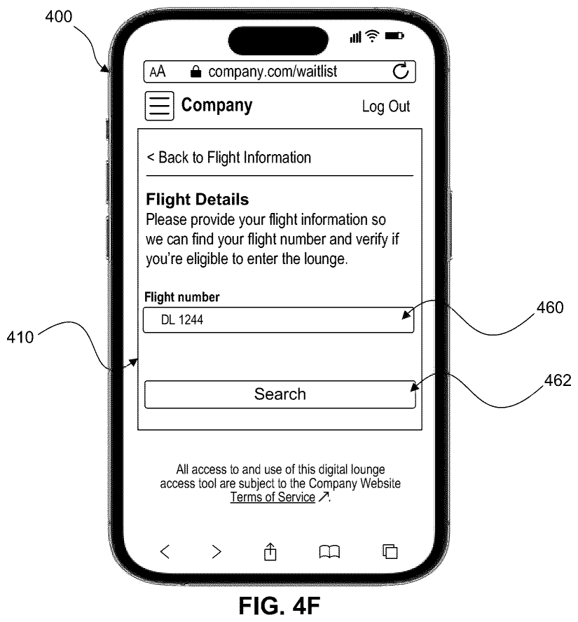

FIG. 4A shows an example user interface 400 for using a multimodal user input to update a digital queue data structure. User interface 400 may be configured to display a variety of graphical user interfaces on user device 104. User interface 400 may be a component of digital queue applications 109 and/or 129. In some aspects, computing device 110 may include programmable instructions configured to transmit interface 400 to user device 104 via a web-based application. For example, computing device 110 may include software and/or hardware that uses communication protocols including, but not limited to HTTP and/or the like to initiate the web-based application to user device 104. The web-based application may include programmable instructions to be utilized by user device 104 and operate therein. In some aspects, user device 104 may include locally stored programmable instructions (e.g., a downloadable application) to initiate display of user interface 400 and the graphical displays described below.

According to some aspects of this disclosure, computing device 110 initiates display of interface 400 based on receiving a digital instrument from list 204. For example, eligibility display 401 may be displayed based on a selection of a particular digital instrument. User device 104 may transmit packetized data associated with digital instrument, such as, but not limited to, a PAN and/or a tokenized PAN. Computing device 110 may evaluate the digital instrument information transmitted by user device 104. Computing device 110 may determine whether interface 400 may be subsequently displayed based on the selected digital instrument. For example, digital queue data structure component 115 may include programmable instructions for determining whether a user device 104 associated with a particular digital instrument may modify a stored digital queue data structure.

According to some aspects of this disclosure, interface 400 may display eligibility display 401. Eligibility display 401 may be configured to display a list of selectable eligibility options 402 (also referred to as list 402) for receiving multimodal user input from user device 104. List 402 may specify a number of multimodal user input options for communicating with and/or updating digital queue data structure component 115. In particular, each multimodal user input option may be configured to update, alter, or otherwise communicate with the digital queue structure component(s) 115.

According to some aspects of this disclosure, the selectable eligibility options of list 402 may be displayed in any order. According to some aspects of this disclosure, list 402 may be ordered according to the frequency in which particular selectable eligibility option is used. Furthermore, computing device 110 may include one or more predictive models specifically trained to rank the selectable eligibility options in list 402 based on various factors including, but not limited to, input type, user preferences, time-of-day, historical facility access data, and/or the like. A predictive model may be specifically trained to rank selectable input options according to other relevant factors, as would be appreciated by one skilled in the art.

To access facility 120 and/or update digital queue data structure component(s) 115, user interface 400 may facilitate the transmission of packetized information from user device 104 across network 102. The packetized information may specify queue and/or user information associated with user device 104. Queue information may relate to the packetized data for triggering updates to the digital queue data structure component 115 (e.g., departure time, passenger name, airline type, flight number, digital instrument, etc.). User information may relate to the packetized data of identifying information (e.g., name, phone number, PAN, etc.). As described above, user device 104 may transmit the packetized information from list 402 of selectable eligibility options. List 402 may include a variety of user input options including, but not limited to, an image scan from an integrated camera of user device 104, a direct image upload from a memory unit of user device 104 and/or a cloud storage environment, an open parameter search, or a strict parameter search.

According to some aspects of this disclosure, computing device 110 may initiate the display of additional graphical displays on user device 104 based on receiving a selection of a selectable eligibility option from list 402. For example, a selection of an eligibility option may cause user device 104 to display an interactive element for confirming and/or providing queue information (e.g., departure time, passenger name, airline type, flight number, digital instrument, etc.) to digital queue data structure component 115. According to some aspects, computing device 110, based on receiving a selection of a multimodal user input option, may cause user device 104 to display an additional display user interface 400, such as displays 404, 406, 408, and 410.

FIG. 4B shows scanning display 404 initiated based on receiving a selection of the respective option from list 402. Scanning display 404 may be integrated within digital queue application 109. Furthermore, scanning display 404 may include an embedded camera 422 integrated within user device 104. In some aspects, computing device 110 may include programmable instructions configured to activate and display embedded camera 422 of user device 104. Accordingly, computing device 110 may, in real-time, extrapolate queue information from the image data captured by embedded camera 422 and map the extrapolated queue information to eligibility criteria defined by digital queue data structure component 115.

According to some aspects of this disclosure, user device 104 may, via digital queue application 109, scan for and isolate encoded data from image (i.e. image data). The encoded data transmitted from user device 104 may be associated with additional information, such as, but not limited to, an IP address, MAC address, and geolocation data of the user device 104 as well as a timestamp of the transmission. The encoded data may resemble a QR code, a bar code, or any comparable identifier capable of encoding queue information. User device 104 may transmit the encoded identifier to computing device 110 based on receiving a selection of a continue button 424. Computing device 110 may extrapolate queue information as well as user information from the scanned image (i.e. readable image data). Computing device 110 may subsequently update a stored data structure within digital queue data structure component(s) 115 with the extrapolated information.

According to some aspects of this disclosure, the queue information may specify a predefined trigger event for updating a stored data structure within digital queue data structure component 115. For example, the predefined trigger event may specify a flight departure time of a user associated with a respective selected digital instrument. Computing device 110 may map the predefined trigger event to eligibility criteria. In some aspects, computing device 110 may compare the predefined trigger event with a timestamp accompanying the transmitted encoded identifier. Based on this eligibility determination, computing device 110 may update digital queue data structure component 119 with the transmitted data.

FIG. 4C shows image upload display 406 initiated based on receiving a selection of the respective option from list 402. Image upload display 406 may be integrated within digital queue application 109. Furthermore, image upload display 406 may be configured to display one or more images 430 stored within the internal memory of user device 104 and/or an external storage environment accessible by user device 104 (e.g., a cloud storage environment). Upon receiving a selection of an image 430, user device 104 may display an indicator 432 that the file is eligible for upload.

According to some aspects of this disclosure and similar to the aspects described in FIG. 4B, user device 104 may, via digital queue application 109, be configured to upload encoded data from image (i.e. image data) to computing device 110. The encoded data uploaded from user device 104 may be associated with additional information, such as, but not limited to, an IP address, MAC address, and geolocation data of the user device 104 as well as a timestamp of the upload. The encoded data may resemble a QR code, a bar code, or any comparable identifier capable of encoding queue information. User device 104 may upload the encoded identifier to computing device 110 based on receiving a selection of an upload button 434. Computing device 110 may extrapolate queue information as well as user information from the uploaded image (i.e. readable image data). Subsequently, computing device 110 may subsequently update a stored data structure within digital queue data structure component(s) 115.

According to some aspects of this disclosure, computing device 110 may determine that an image 430 does not contain encoded data associated with queue information. Accordingly, computing device 110 may transmit an error message to user device 104. The error message may be displayed on upload display 406.

FIG. 4D shows open parameter search display 408 initiated based on receiving a selection of the respective option from list 402. Open parameter search display 408 may be integrated within digital queue application 109. Open parameter search display 408 may display a variety of parameters. The parameters may include, but are not limited to, airline 440, departure airport 442, arrival airport 444, and/or scheduled departure time 446.

According to some aspects of this disclosure and similar to the aspects described in FIGS. 4B-4C, user device 104 may, via digital queue application 109, be configured to transmit the parameters to computing device 110. The parameters may be associated with additional information, such as, but not limited to, an IP address, MAC address, and geolocation data of the user device 104 as well as a timestamp of the upload. User device 104 may transmit the parameters to computing device 110 based on receiving a selection of a search button 448.

According to some aspects of this disclosure, computing device 110 may query a database to retrieve entries corresponding to the received parameters. Computing device 110 may query a database in a third-party system 116 via an application programing interface (API). Computing device 110 may also query a self-contained database, such as a database within digital queue data structure component 115. Computing device 110 may retrieve entries that exactly match the received parameters and/or exceed a similarity threshold. For example, computing device 110 may score a set of transmitted parameters based on the number of matched parameters from the queried database. Computing device 110 may retrieve entries if the scored set of transmitted parameters exceeds the similarity threshold.

According to some aspects of this disclosure, computing device 110 may transmit the retrieved entries to user device 104. User device 104 may display the retrieved entries on an updated open parameter search display 408, as shown in FIG. 4E. Open parameter search display 408 may display selectable entries 450a and 450b. The selectable entries 450 may reflect a data object containing queue information. According to some aspects, user device 104 may transmit the data object to digital queue data structure component 115 based on receiving a selection of a continue button 452. Computing device 110 may perform an eligibility determination using the received data object.

According to some aspects of this disclosure, user device 104 may receive a selection of a manual verification button 454. Subsequently, user device 104 may transmit an indicator to computer device 110. The indicator may specify that updates to digital queue data structure component 115 are to be manually verified for user device 104. Computing device 110 may transmit the indicator to administrator device 124.

According to some aspects of this disclosure, computing device 110 may determine that the inputted parameters are not associated with queue information. Accordingly, computing device 110 may transmit an error message to user device 104. The error message may be displayed on open parameter search display 408.

FIG. 4F shows strict parameter search display 410 initiated based on receiving a selection of the respective option from list 402. Strict parameter search display 410 may be integrated within digital queue application 109. Strict parameter search display 410 may display a variety of parameters. In one particular aspect, strict parameter search display may include a flight number parameter 460.

According to some aspects of this disclosure and similar to the aspects described in FIGS. 4B-4D, user device 104 may, via digital queue application 109, be configured to transmit the parameter(s) to computing device 110. The parameter(s) may be associated with additional information, such as, but not limited to, an IP address, MAC address, and geolocation data of the user device 104 as well as a timestamp of the upload. User device 104 may transmit the parameter(s) to computing device 110 based on receiving a selection of a search button 462.

According to some aspects, computing device 110 may perform a strict parameter search to find an exact match of the received parameters exact match text search. For example, user device 104 may transmit the string of characters reflecting flight number parameter 460 to computing device 110. Computing device 110 may query a database in a third-party system 116 via an application programing interface (API) or a database contained within computing device 110, such as within digital queue data structure component 115. Computing device 110 may retrieve a data object containing a value that exactly matches the value corresponding to flight number parameter 460. Computing device 110 may perform an eligibility determination using the retrieved data object.

According to some aspects of this disclosure, computing device 110 may determine that the received parameter(s) is not associated with queue information. Accordingly, computing device 110 may transmit an error message to user device 104. The error message may be displayed on strict parameter search display 410.

According to some aspects of this disclosure, digital queue application 109 may be configured to receive user input in the form of alphanumeric characters in a parameter field, such as flight number parameter 460. In some aspects, strict parameter search display 410 may include additional parameters used for updating digital queue data structure 115. For example, the additional parameters may include, but are not limited to, seat number and/or boarding group.

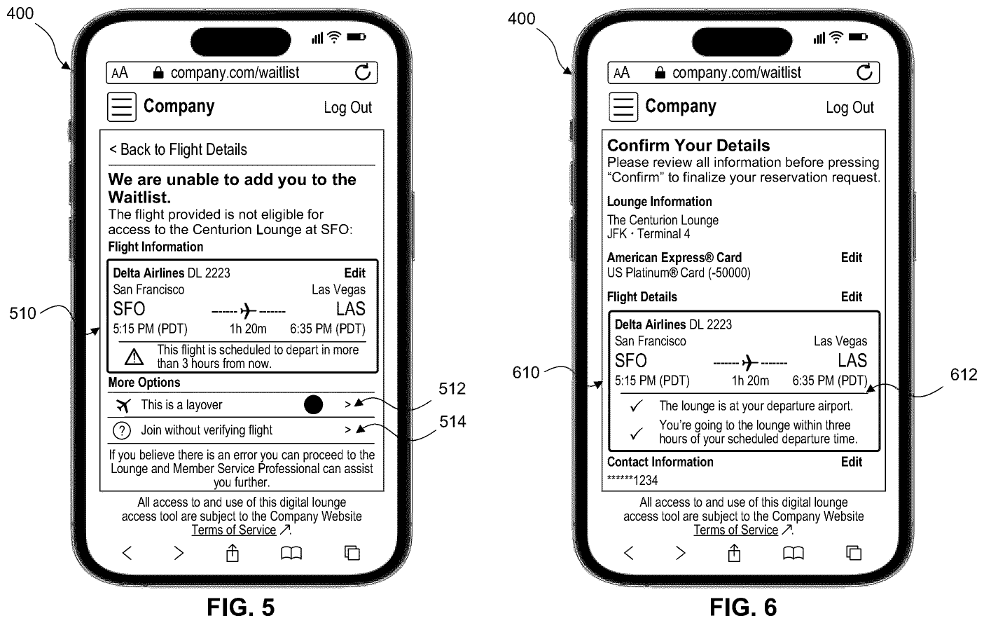

FIG. 5 shows an example interface 400 indicating that the digital queue data structure has not been updated based on the multimodal user input, according to some aspects. Rejection display 510 may be integrated within digital queue application 109. FIG. 5 shall be described with reference to FIGS. 4A-4F. However, FIG. 5 shall not be limited to these example aspects.

According to some aspects of this disclosure, computing device 110 may initiate display of rejection display 510 based on received multimodal user input. For example, digital queue data structure component 115 may determine that the received and extrapolated queue information does not meet defined eligibility criteria to enter a facility 120. Accordingly, digital queue data structure component 115 may will not update a stored data structure contained therein. Accordingly, digital queue data structure component 115 may cause the user device 104 to display a rejection display 510.

According to some aspects of this disclosure, rejection interface 510 may display additional eligibility options on the user device 104. For example, rejection display 510 may include a layover button 512 and a manual verification button 514. A selection of an additional eligibility option may cause user device 104 to transmit an alternate indicator to digital queue data structure component 115. If user device 104 receives a selection of a layover button 512, then the user device 104 may transmit a layover indicator to digital queue data structure component 115. Accordingly, digital queue data structure component 115 may update the data structure(s) stored therein despite the queue information not fulfilling defined eligibility criteria. Moreover, digital queue data structure component 115 may perform additional verification steps to determine the queue information corresponds to a layover flight. Accordingly, digital queue data structure component 115 may update stored data structure(s) with the queue information. Additionally, computing device 110 may initiate display of an acceptance display, such as confirmation display 610.

According to some aspects of this disclosure, user device 104 may receive a selection of manual verification button 514. Accordingly, computing device 110 may receive a manual verification indicator transmitted from user device 104. If computing device 110 receives a manual verification indicator, computing device 110 may transmit the manual verification indicator to administrator device 124. Thus, administrator device 124 may be configured to perform additional authentication steps with user device 104 and/or a user of user device 104.

FIG. 6 shows an example interface 400 of a confirmation display 610 indicating that the digital queue data structure has been updated based on the multimodal user input, according to some aspects. FIG. 6 shall be described with reference to FIGS. 4A-4F. However, FIG. 6 shall not be limited to these example aspects.

According to some aspects of this disclosure, confirmation display 610 may include confirmation information 612. Confirmation information 612 may be transmitted to user device 104 by computing device 110. Confirmation information 612 may also be transmitted to administrator device 124 managing facility 120. Confirmation information 612 may include information relating to a particular flight included in the queue information. Confirmation information 612 may also include additional data such as, but not limited to, confirmation text, contact information from the queue information, a digital instrument, and/or a particular facility 120. Confirmation information 612 may also be encoded by a QR code, bar code and/or another mechanism for encoding data.

According to some aspects of this disclosure, computing device 110 may initiate display of a confirmation display 610 based on received multimodal user input(s). For example, digital queue data structure component 115 may determine that received and extrapolated queue information satisfies a particular eligibility criteria. Digital queue data structure component 115 may update stored data structures to include the queue information transmitted by user device 104. In particular, digital queue data structure component 115 may update the stored data structure(s) to indicate that a user associated with the transmitted queue information is eligible to enter a facility 120.

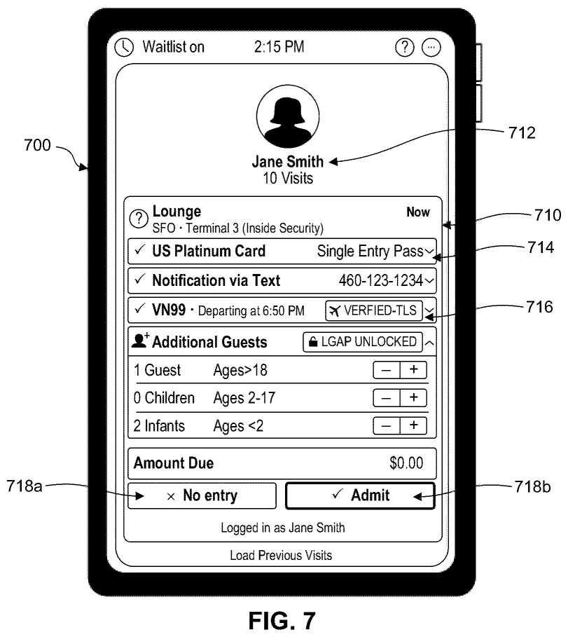

FIG. 7 shows an example administrator interface 700 for an administrator device 124 receiving an updated digital queue data structure, according to some aspects of this disclosure. FIG. 7 shall be described with reference to FIGS. 4A-4F and 5-6. However, FIG. 7 is not limited to these example aspects.

According to some aspects, administrator interface 700 is configured to display an administrator display 710. Administrator interface 700 may be displayed by administrator device 124. In some aspects, computing device 110 may initiate display of administrator display 710. For example, computing device 110 may transmit an updated digital queue data structure from digital queue data structure component 115 to administrator device 124. Administrator display 710 may be integrated within digital queue application 129.

According to some aspects, administrator display 710 may include queue and/or user information received from computing device 110, such as name 712, digital instrument 714, and/or verification indicator 716. Eligibility display 710 may also include additional information such as, but not limited to, a number of additional guests and a total amount due. Moreover, eligibility display 710 may include other information relevant to a particular facility 120, such as a facility title, location, and a type (e.g., a lounge).

According to some aspects, verification indicator 716 may resemble a graphical representation of the eligibility operations performed by computing device 110. As described in FIGS. 4A-4F, computing device 110 may receive and validate transmitted multimodal inputs from user device 104. Based on the type of validated user input, computing device 110 may store an additional identifier corresponding the respective update to digital queue data structure component 115. The additional identifier may vary based on how the multimodal input was validated (i.e., the selected eligibility option from list 402). For example, digital queue data structure 115 may include an identifier specifying that the received queue information was deemed eligible through a scanned image, image upload, open parameter search, strict parameter search, and/or a proprietary application within computing device 110 (e.g., a related application stored within computing device 110). Accordingly, eligibility display 710 may display a verification indicator 716 based on how the queue information was received and/or verified. Administrator device 124 may display the verification indicator 716 based on programmable instructions executed by computing device 110 and/or locally stored programmable instructions executed from digital queue application 129.

According to some aspects, eligibility display 710 may include entry buttons 718. Administrator device 124 may receive a selection of an entry denial button 718a or an entry admittance button 718b. Administrator device 124 may transmit an entry indicator to digital queue data structure component 115 based on the selection of an entry button 718.

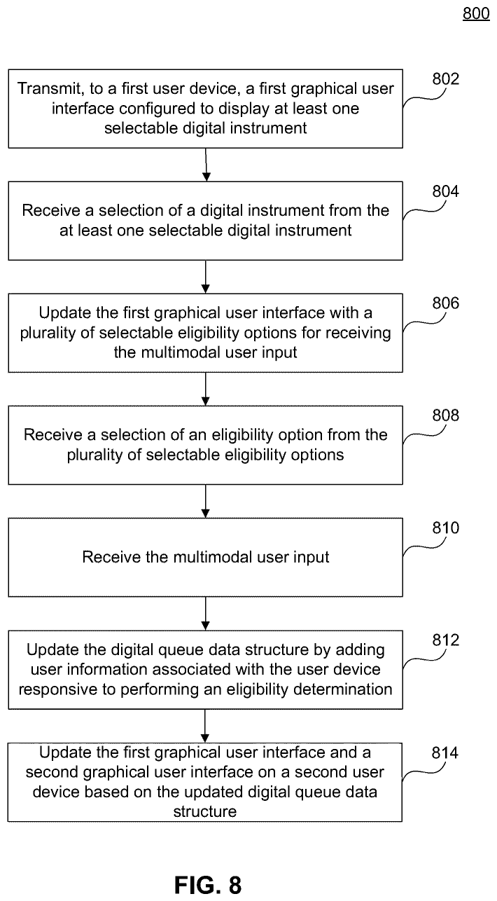

FIG. 8 shows a flowchart of an example method 800 for using a multimodal user input interface to update a digital queue data structure, according to some aspects. Method 800 shall be described with reference to FIGS. 2, 4A-4F, and 5-7. However, method 800 is not limited to these example aspects.

In 802, computing device 110 transmits, to a first user device, a first graphical user interface configured to display at least one selectable digital instrument. For example, computing device 110 may transmit the first graphical user interface to user device 104. User device 104 may display the first graphical user interface via digital queue application 109. The graphical user interface may resemble interface 200 of FIG. 2B.

In 804, computing device 110 receives a selection of a digital instrument from the at least one selectable digital instrument. For example, computing device 110 may receive a selection of a digital instrument from user device 104. In some aspects, user device 104 may transmit a PAN, a tokenized PAN, and/or other account identifiers associated with the digital instrument to digital queue data structure component 115.

In 806, computing device 110 updates the first graphical user interface with a plurality of selectable eligibility options for receiving the multimodal user input based on the selection of the digital instrument. The updated graphical user interface may reflect eligibility display 401 including the list of selectable eligibility options 402. Computing device 110 may be configured to limit the selectable eligibility options from list 402 based on the received digital instrument of 804. In some aspects, the list of selectable eligibility options 402 may include, but not limited to, an image scan from an integrated camera of user device 104, a direct image upload from a memory unit of user device 104 and/or a cloud storage environment, an open parameter search, or a strict parameter search.

In 808, computing device 110 receives a selection of an eligibility option from the plurality of selectable eligibility options. For example, computing device 110 may receive a selection of an eligibility option from the list of selectable eligibility options 402. The selection may be transmitted from user device 104 to computing device 110. Accordingly, computing device 110 may update the display of the user device 104 based on the type of eligibility option selected. Computing device 110 may then update the digital queue application 104 based on packetized queue information data received through displays 404, 406, 408, and/or 410. As described above, displays 404, 406, 408, or 410 reflect different techniques in which user device 104 transmits queue information and how computing devices 110 standardizes the information received from each input into a data object capable of being stored within digital queue data structure component 115.

In 810, computing device 110 receives, via the first graphical user interface and responsive to the selection of the eligibility option, the multimodal user input. The multimodal user input may include queue information associated with a predefined trigger event. The predefined trigger event may be used for updating digital queue data structure component 115. In some aspects, the predefined trigger event is a departure time of a flight. Additionally, the queue information may include characteristics of the user device 104 such as, but not limited to, an IP address, MAC address, and geolocation data of the user device 104 as well as a timestamp of the transmission. The queue information may also include information relating to a particular flight (e.g., flight number, seat number, boarding group, etc.)

According to some aspects of this disclosure, digital queue data structure component 115 may include eligibility criteria. Digital queue data structure component 115 may compare the eligibility criteria with the received predefined trigger event, as well as other queue information. For example, digital queue data structure component 115 may include for example eligibility criteria for updating the digital queue data structure component 115. Computing device 110 may receive the multimodal user input from user device 104.

In some aspects, the eligibility criteria may specify a particular digital instrument that is eligibility to enter a facility 120 as well as information derived from the input itself. For example, if a user device 104 transmits barcode and/or QR code information from user camera 422 to computing device 110, computing device 110 may parse the image information. Additionally, computing device 110 may also be configured to parse image information 430 directly uploaded from user device 104 and/or perform text searches in according with displays 408 and 410.

In some aspects, the eligibility criteria may Computing device 110 may parse the image data into readable image data. For example, computing device 110 may use a machine learning model and/or configurable coded instructions to read image data received from a user device 104. Computing system may parse the information into readable image data for updating and modifying a digital queue data structure component 115. The readable image data comprises may include information associated with the predefined trigger event. Computing device 110 may extrapolate the predefined trigger event based on the text data and readable image data and map the predefined trigger event to the eligibility criteria. For example, the readable image data may include a departure time of a particular flight, which may be a trigger event for determining eligibility. In some aspects, if a user submits the multimodal user input a period of time (e.g., 3 hours) before the departure time extrapolated from the image data, computing device 110 may update the digital queue data structure component 115 accordingly.

In step 812, computing device 110 may update the digital queue data structure component 115 by adding user information associated with the user device 104 responsive to performing an eligibility determination. Based on the information received, parse, and/or otherwise operated upon, computing device 110 in step 810, computing device 110 may update the digital queue data structure components 115 to include the user information transmitted from user device 104 (e.g., a name, a card type, and flight information). The eligibility determination may be based on the queue information meeting the eligibility criteria as determined in step 810.

In some aspects, computing device 110 may update at least one additional digital queue data structure components 115 by adding the user information associated with user device 104 responsive to performing an additional eligibility determination. For example, computing device 110 may perform additional eligibility determinations for a particular data structure component 115 that corresponds to another facility 120. The at least one additional digital queue data structure components 115 may include different eligibility criteria and/or the same eligibility criteria described in step 808. The additional eligibility determination may include an additional predefined trigger event to the eligibility criteria. For example, the additional predefined trigger event may correspond to another departure time transmitted from user device 104 to computing device 110.

In 814, computing device 110 may update the first graphical user interface of the first user device and a second graphical user interface on a second user device based on the updated digital queue data structure component 115.

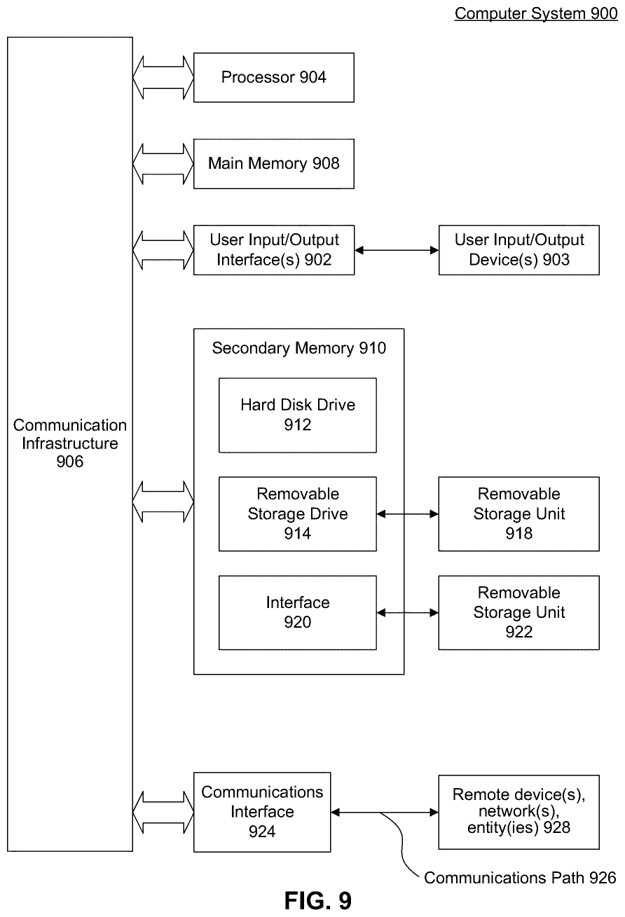

Various aspects may be implemented, for example, using one or more well-known computer systems, such as computer system 900 shown in FIG. 9. One or more computer systems 900 may be used, for example, to implement any of the aspects discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 428). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 9. In particular, the aspects can operate with software, hardware, and/or operating system implementations other than those described herein.

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, the aspects (whether or not explicitly described herein) have significant utility to fields and applications beyond the examples described herein.

The aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method for using multimodal user input to update a digital queue data structure, the computer-implemented method comprising:
transmitting, to a first user device, a first graphical user interface configured to display at least one selectable digital instrument;
receiving a selection of a digital instrument from the at least one selectable digital instrument;
updating the first graphical user interface with a plurality of selectable eligibility options for receiving the multimodal user input, wherein the plurality of selectable options is based on the selection of the digital instrument;
receiving a selection of an eligibility option from the plurality of selectable eligibility options;
receiving, via the first graphical user interface and responsive to the selection of the eligibility option, the multimodal user input, wherein the multimodal user input comprises queue information associated with a predefined trigger event for updating the digital queue data structure, and wherein the digital queue data structure comprises eligibility criteria for updating the digital queue data structure;
updating the digital queue data structure by adding user information associated with the first user device responsive to performing an eligibility determination, wherein the eligibility determination is based on the queue information meeting the eligibility criteria; and
updating the first graphical user interface and a second graphical user interface on a second user device based on the updated digital queue data structure, wherein the updating first the graphical user interface comprises rendering a visual identifier based on the eligibility determination.

2. The computer-implemented method of claim 1, wherein the first graphical user interface is configured within a web application transmitted to the first user device.

3. The computer-implemented method of claim 1, wherein the first graphical user interface is configured within a mobile application transmitted the first user device.

4. The computer-implemented method of claim 1, wherein the updating the second graphical user interface further comprises:
transmitting the updated digital queue data structure to the second user device such that the updated digital queue data structure is displayed by the second user device; and
rendering a verification indicator on the second user device based on the eligibility determination and the selection of the eligibility option.

5. The computer-implemented method of claim 1, wherein the queue information further comprises a combination of text data and image data received from the user device, the method further comprising:
parsing the image data into readable image data, wherein the readable image data comprises additional information associated with the predefined trigger event;
extrapolating the predefined trigger event based on the text data and readable image data; and
mapping the predefined trigger event to the eligibility criteria.

6. The computer-implemented method of claim 1, wherein the visual identifier associated with the eligibility determination comprises a Quick Response (QR) code, bar code, or an alphanumeric indicator.

7. The computer-implemented method of claim 1, further comprising:
transmitting an eligibility notification to the first user device, wherein the eligibility notification comprises information associated with the eligibility determination; and
embedding the eligibility notification within the first graphical user interface of the first device.

8. The computer-implemented method of claim 1, further comprising:
updating at least one additional digital queue data structure by adding the user information associated with the first user device responsive to performing an additional eligibility determination, wherein the at least one additional digital queue data structures comprise the eligibility criteria, and wherein the additional eligibility determination comprises mapping an additional predefined trigger event to the eligibility criteria.

9. The computer-implemented method of claim 1, wherein the plurality of selectable options comprises a strict parameter search option, an open parameter search option, an image upload option, or an embedded camera scan option.

10. The computer-implemented method of claim 9, further comprises:
in response to receiving a selection of the embedded camera scan option, activating a camera embedded within the first graphical user interface of the first user device;
mapping, in-real time, the multimodal user input to an image taken by the camera embedded within the first graphical user interface.

11. A system, comprising:
a memory; and
at least one processor coupled to the memory and configured to perform operations comprising:
transmitting, to a first user device, a first graphical user interface configured to display at least one selectable digital instrument;
receiving a selection of a digital instrument from the at least one selectable digital instrument;
updating the first graphical user interface with a plurality of selectable eligibility options for receiving the multimodal user input, wherein the plurality of selectable options is based on the selection of the digital instrument;
receiving a selection of an eligibility option from the plurality of selectable eligibility options;
receiving, via the first graphical user interface and responsive to the selection of the eligibility option, the multimodal user input, wherein the multimodal user input comprises queue information associated with a predefined trigger event for updating the digital queue data structure, and wherein the digital queue data structure comprises eligibility criteria for updating the digital queue data structure;
updating the digital queue data structure by adding user information associated with the first user device responsive to performing an eligibility determination, wherein the eligibility determination is based on the queue information meeting the eligibility criteria; and
updating the first graphical user interface and a second graphical user interface on a second user device based on the updated digital queue data structure, wherein updating first the graphical user interface comprises generating a visual identifier based on the eligibility determination.

12. The system of claim 10, wherein the first graphical user interface is configured within a mobile application provided the first user device.

13. The system of claim 10, wherein the first graphical user interface is configured within a web application provided the first user device.

14. The system of claim 10, wherein the updating the second graphical user interface further comprises:
transmitting the updated digital queue data structure to the second user device such that the updated digital queue data structure is displayed by the second user device; and
rendering a verification indicator based on the eligibility determination and the selection of the eligibility option.

15. The system of claim 10, wherein the queue information further comprises a combination of text data and image data received from the user device, the system further comprising:
parsing the image data into readable image data, wherein the readable image data comprises additional information associated with the predefined trigger event;
extrapolating the predefined trigger event based on the text data and readable image data; and
mapping the predefined trigger event to the eligibility criteria.

16. The system of claim 10, wherein the visual identifier associated with the eligibility determination comprises a Quick Response (QR) code, bar code, or an alphanumeric indicator.

17. The system of claim 10, the system further comprising:
transmitting an eligibility notification to the first user device, wherein the eligibility message comprises information associated with the eligibility determination; and
embedding the eligibility notification within the first graphical user interface of the first device.

18. The system of claim 10, wherein the plurality of selectable eligibility options comprises a strict parameter search option, an open parameter search option, an image upload option, or an embedded camera scan option.

19. The system of claim 18, the system further comprising:
in response to receiving a selection of the embedded camera scan option, activating a camera embedded within the first graphical user interface of the first user device;
mapping, in-real time, the multimodal user input to an image taken by the camera.

20. A non-transitory computer-readable medium having instructions stored thereon that, when executed by at least one computing device, causes the at least one computing device to perform operations comprising:
transmitting, to a first user device, a first graphical user interface configured to display at least one selectable digital instrument;
receiving a selection of a digital instrument from the at least one selectable digital instrument;
updating the first graphical user interface with a plurality of selectable eligibility options for receiving the multimodal user input, wherein the plurality of selectable options is based on the selection of the digital instrument;
receiving a selection of an eligibility option from the plurality of selectable eligibility options;
receiving, via the first graphical user interface and responsive to the selection of the eligibility option, the multimodal user input, wherein the multimodal user input comprises queue information associated with a predefined trigger event for updating the digital queue data structure, and wherein the digital queue data structure comprises eligibility criteria for updating the digital queue data structure;
updating the digital queue data structure by adding user information associated with the first user device responsive to performing an eligibility determination, wherein the eligibility determination is based on the queue information meeting the eligibility criteria; and
updating the first graphical user interface and a second graphical user interface on a second user device based on the updated digital queue data structure, wherein updating first the graphical user interface comprises generating a visual identifier based on the eligibility determination.
